(19) United States
(12) Patent Application Publication
(10) Pub. No.: US 2012/0322617 A1
(43) Pub. Date: Dec. 20, 2012

(54) REVERSE SPEED CONTROL APPARATUS

(75) Inventors: Akihiro Takahashi, Kariya-city (JP); Tomohiro Tsujimura, Obu-city (JP)

(73) Assignee: DENSO CORPORATION, Kariya-city (JP)

(21) Appl. No.: 13/527,999

(22) Filed: Jun. 20, 2012

(30) Foreign Application Priority Data
Jun. 20, 2011 (JP) 2011-135903

(51) Int. Cl. B60W 10/10

(52) U.S. Cl. 477/96

(57) ABSTRACT

A reverse speed control apparatus for controlling a reverse speed of the vehicle may include a brake operation detection unit, a shift range detection unit, and a reverse speed restriction unit. The brake operation detection unit detects a brake operation and a brake release of brakes disposed in the vehicle, and the shift range detection unit detects a shift range of the vehicle. Based on the brake operation detection unit and the shift range detection unit, the reverse speed restriction unit performs a restriction on a reverse speed of the vehicle in accordance with a restriction speed threshold. Specifically, when a brake operation is detected and the shift range of the vehicle is in a reverse range, the reverse speed restriction unit performs the restriction on the reverse speed of the vehicle for a preset period of time when a brake release is detected.

### CROSS REFERENCE TO RELATED APPLICATION

This application is based on and claims the benefit of priority of Japanese Patent Application No. 2011-135903 filed on Jun. 20, 2011, the disclosure of which is incorporated herein by reference.

### TECHNICAL FIELD

The present disclosure generally relates to a reverse speed control apparatus that associates a travel speed of a vehicle during a reverse travel with a brake operation to restrict the reverse speed.

### BACKGROUND

When a driver of a vehicle intends to step on a brake pedal during a reverse travel of the vehicle, the driver may unintentionally step on the accelerator pedal. In such a case, the vehicle may accelerate and may bump into an object, such as a vehicle.

In order to prevent such a situation, a technique in Japanese Patent Laid-Open No. 2003-56371 (JP '371) determines a mis-operation of the accelerator pedal by the driver and restricts an output from the engine, which serves as a power source of the vehicle, when the driver suddenly steps on the accelerator pedal. Specifically, when both an operation amount of the accelerator pedal and an operation speed of the accelerator pedal are above a certain threshold without performing any brake operation at a time of changing the drive mode to reverse or reverse gear. The restriction on the engine for limiting an increase of an engine rotation speed is accomplished by restricting a throttle opening, restricting a throttle opening speed, or by cutting a fuel injection.

Further, Japanese Patent Laid-Open No. 2009-126352 (JP '352) discloses a technique that prevents a steep acceleration of the vehicle when a mis-operation of a shift lever or of a pedal is detected. The technique is implemented as restricting an acceleration of the vehicle that is substantially stopping (i.e., a speed of 5 km/h or less). Such restriction is provided for either an acceleration time period to a preset speed limit or for a preset lapse time after a start of acceleration. In such restriction, an acceleration restriction value may be set to different values depending on a travel direction of the vehicle (i.e., a shift range), a recognition result of the posture of the driver by using a camera, and/or a vehicle speed. Restriction on the acceleration is realized through a brake operation control, an engine output restriction control (i.e., a fuel supply control) or the like.

However, even when the engine output is restricted for handling the mis-operation of the accelerator pedal as disclosed in JP '371, the vehicle speed may still increase with by way of the automatic transmission, which automatically shifts the gear. Further, due to the configuration for automatic determination of the accelerator pedal mis-operation when the driver suddenly steps on the accelerator pedal without performing any brake operation when shifting to the reverse range, the mis-operation (i.e., an inadvertent steep/sudden operation) of the accelerator pedal will not be detected and the engine output will not be restricted if the driver has performed a brake operation at least once after shifting to the reverse range.

Further, just by restricting the acceleration of the vehicle speed as disclosed in JP '352, the increase of the vehicle speed will not be prevented, since the acceleration restriction will only suppress a steep acceleration of the vehicle speed to be a more gradual one but not prohibiting the acceleration itself.

Furthermore, when the driver intentionally operates the accelerator pedal steeply/largely to have a required vehicle driving torque for, for example, driving a substantially stopping vehicle over a bump/difference, such acceleration may also be restricted by the technique of JP '352, thereby not fulfilling the driver's intention for increasing the vehicle driving torque.

### SUMMARY

In an aspect of the present disclosure, a reverse speed control apparatus includes a brake operation detection unit, a shift range detection unit, and a reverse speed restriction unit. The brake operation detection unit detects a brake operation and a brake release of brakes disposed in the vehicle. The shift range detection unit detects a shift range of the vehicle. Based on the brake operation detection unit and the shift range detection unit, the reverse speed restriction unit performs a restriction on a reverse speed of the vehicle in accordance with a restriction speed threshold. Specifically, when a brake operation is detected by the brake operation detection unit and the shift range of the vehicle is in a reverse range, the reverse speed restriction unit performs the restriction on the reverse speed of the vehicle for a preset period of time when a brake release is detected by the brake operation detection unit.

Generally speaking, when the driver changes the shift range of the vehicle to the reverse range, the driver most likely changes the shift range to the reverse range while performing a brake operation (i.e., while operating/stepping on the brake pedal). When the driver releases the brake pedal after shifting to the reverse range, the reverse speed restriction unit restricts the reverse speed of the vehicle. In such manner, the reverse speed control apparatus prevents an unintentional increase of a reverse speed of the vehicle to an excessive degree in order to prevent a possible mis-operation. Specifically, the driver may have mistakenly placed the vehicle in the reverse range or may have forgotten the vehicle is in the reverse range.

In addition, the reverse speed restriction unit may release the restriction on the reverse speed after a preset period of time from a start of the restriction. In such manner, when the driver continues to travel in the reverse direction, the reverse speed restriction is released, thereby allowing an increase of the reverse speed according to an operation of the accelerator pedal.

### BRIEF DESCRIPTION OF THE DRAWINGS

Other objects, features and advantages of the present invention will become more apparent from the following detailed description made with reference to the accompanying drawings, in which:

FIG. 1 is a block diagram of a vehicle control system in a first embodiment of the present disclosure;

FIG. 2 is a flowchart of a vehicle reverse speed control process in the first embodiment of the present disclosure;

FIG. 3 is a time chart of vehicle reverse speed control in the first embodiment of the present disclosure;

FIG. 4 is a flowchart of a vehicle reverse speed control process in a second embodiment of the present disclosure; and

FIG. 5 is a time chart of vehicle reverse speed control in the second embodiment of the present disclosure.

### DETAILED DESCRIPTION

The present disclosure is now described in more detail with reference to the drawings.

### First Embodiment

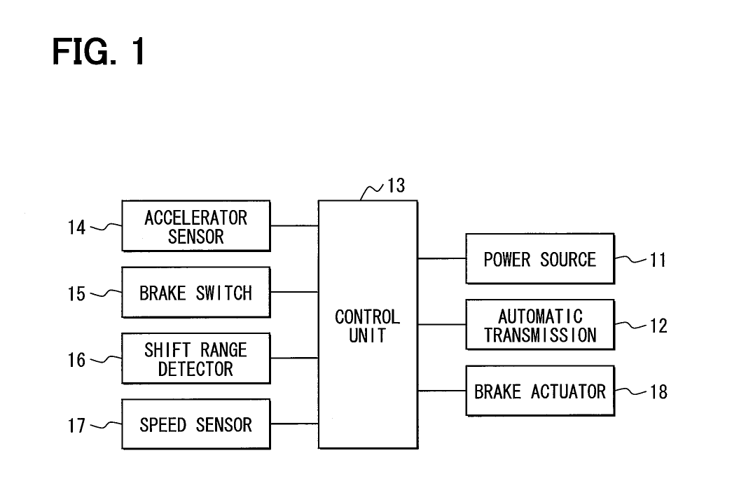

With reference to FIG. 1, a vehicle control system of a vehicle includes a power source 11 to provide the driving power of the vehicle. The power source may be an internal combustion engine, a motor, or a combination of an engine and a motor. An output from the power source 11 is transmitted through an automatic transmission 12 and a propeller shaft (not illustrated) to rotate the tires (not illustrated) of the vehicle.

The vehicle control system also includes a control unit 13 for controlling the power source 11 and the automatic transmission 12, and may be implemented as one or more ECUs (i.e., a microcomputer). The control unit 13 is coupled to various components, such as an accelerator sensor 14, a brake switch 15, a shift range detector 16, and a speed sensor 17, as well as other sensors and switches. The accelerator sensor 14 detects the extent of depression or actuation of an accelerator pedal by a driver of the vehicle (i.e., an amount of stepping operation of an accelerator pedal). The brake switch 15 (i.e., a brake operation detection unit in claims) detects a brake operation or the extent of depression or actuation of a brake pedal (i.e., an amount of stepping operation of the brake pedal) by the driver. The shift range detector 16 (i.e., a shift range detection unit in claims) detects a shift range (i.e., gear), such as park, neutral, drive, and reverse, selected by a shift operation by the driver. The speed sensor 17 detects a speed of the vehicle.

A brake actuator 18, disposed in the vehicle, electrically controls a braking force of brakes disposed in the vehicle. The brake actuator 18 electrically controls the braking force based on a brake operation request from the control unit 13. The brake operation request may be generated even when the driver is not performing a brake operation (i.e., not stepping on the brake pedal).

The control unit 13 executes a vehicle reverse speed control process, and functions as a reverse speed restriction unit to restrict or limit the reverse speed of the vehicle under a predetermined condition after having detected that the driver has shifted a gear into a reverse range (i.e., an R-range) while performing a brake operation (i.e. actuating or stepping on the brakes). The reverse speed is provided as a speed of the vehicle when the vehicle is traveling in the reverse range, or, in other words, in the reverse gear.

In the present disclosure, the reverse speed restriction may be continued until the reverse travel of the vehicle is completed by, for example, shifting the drive direction of vehicle from the R-range to another range/another gear. However, when the driver intentionally continues traveling in reverse for longer than usually-expected distance, the restriction of the reverse speed may be inconvenient to the driver.

Therefore, in the present embodiment, the restriction on the reverse speed of the vehicle is released after a preset period of time from the start of the reverse speed restriction. In such manner, after the preset period of time from the start of the reverse speed restriction has lapsed, the control unit 13 may increase the reverse speed of the vehicle in the middle of the reverse travel according to an operation of the accelerator pedal by the driver. The preset period of time may be referred to as a restriction threshold,

Specifically, after the vehicle is changed to the R-range with the brake operation, the first release of the brake is used as a start time of the reverse speed restriction. In other words, when the brake is first released, after changing to the R-range, the start of a restriction or limitation of the reverse speed begins, and when the duration of the restriction reaches the preset period of time, the restriction is discontinued. The described control assumes a mis-operation of mistaking the accelerator pedal for the brake pedal at the time of the first release of the brake after shifting to the R-range. Therefore, for the purpose of preventing the mis-operation of mistaking the accelerator pedal for the brake pedal, a restriction on the reverse speed of the vehicle is imposed for a preset period of time from the first release of the brake.

In addition, if the driver of the vehicle is actuating the accelerator pedal with, for example, a large amount of force when the restriction of the reverse speed lapses and is discontinued, the release of the restriction may lead to a sudden and steep increase of the reverse speed of the vehicle. Therefore, as a preventive measure, the reverse speed of the vehicle is gradually increased after the restriction is discontinued. In such manner, even if the driver of the vehicle is actuating on the accelerator pedal at the time the restriction on the reverse speed is released, a sudden and steep increase of the reverse speed of the vehicle is prevented.

In order to restrict the reverse speed, the output of the power source 11 may be controlled. However, such configuration may work against the intention of the driver. For example, the driver may actuate the accelerator pedal for a bigger vehicle drive torque to perform a specific driving function, such as going over a bump, from a substantially stopping condition. Therefore, the restriction of the reverse speed may be performed by at least one of an operation control of the brake actuator 18, a shift control of the automatic transmission 12, and/or a slip control of a clutch, without restricting the output of the power source 11 (e.g. engine) for the reverse travel of the vehicle.

During the restriction of the reverse speed, the speed of the vehicle is maintained at or below a restriction speed threshold. Specifically, when the reverse speed of the vehicle is substantially close to exceed the restriction speed threshold, a feedback control is performed for restricting the reverse speed and for restricting the reverse speed detected by the speed sensor 17 within the restriction speed threshold of the reverse travel, as at least one of a feedback to an operation of the brake actuator 18 (i.e., a feedback to a braking force), a feedback to a shift ratio of the automatic transmission 12, and a feedback to a slip ratio of the lock-up clutch. In such manner, the engine torque for driving the vehicle will not be restricted during the restriction threshold of the reverse speed.

If the power source 11 for the reverse travel of the vehicle is a motor, the reverse speed may be restricted by controlling/restricting the rotation speed of the motor as the restriction on the reverse speed of the vehicle. In such manner, the restriction on the reverse speed of the vehicle can be easily performed. Further, the restriction on the reverse speed may be performed by the feedback control of the brake actuator 18 and the like when the power source 11 is the motor, just like a case that the power source 11 is the engine.

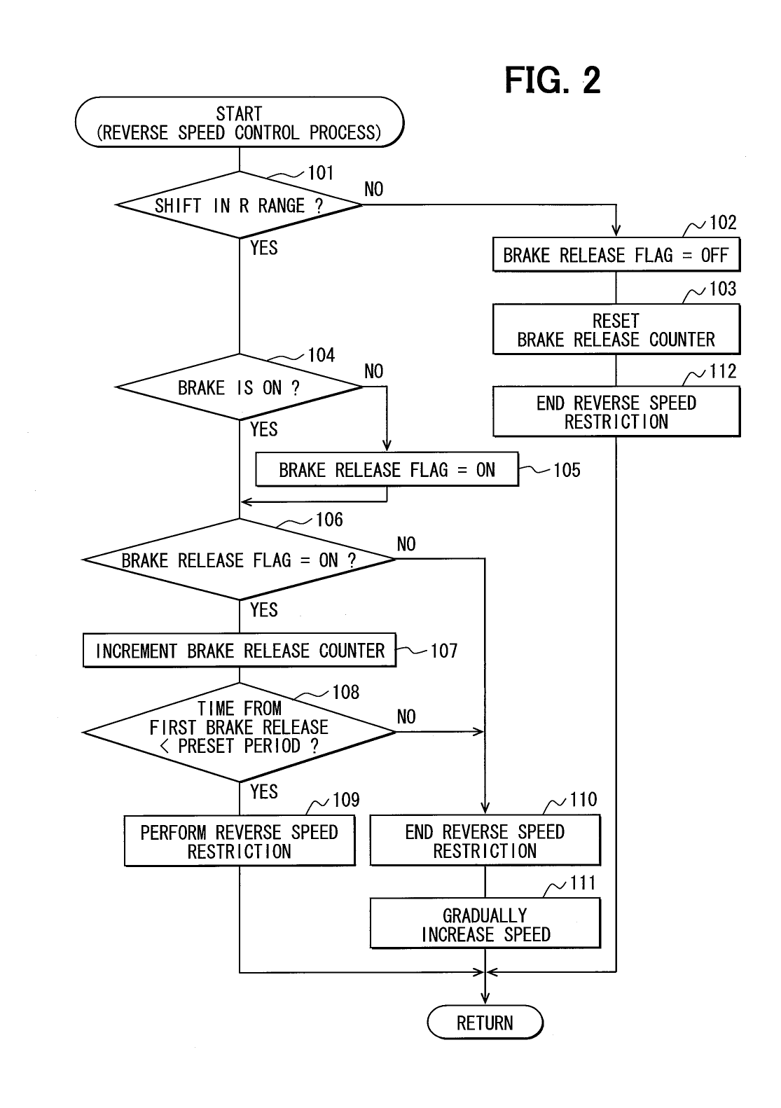

With reference to FIG. 2, the vehicle reverse speed control process, which is executed by the control unit 13, is executed repeatedly at regular intervals during a power-on time of the control unit 13. The vehicle reverse speed control process serves as a reverse speed restriction unit in claims.

The process, in 101, determines whether the current shift range detected by the shift range detector 16 is in the R-range. If the current shift range is not in the R-range (101:No), the process proceeds to 102, where a brake release flag is reset to OFF, or, if it is already OFF, the OFF state of the brake release flag is kept unchanged. The brake release flag is switched to an ON state when the brake is first released after the shift range is changed to the R-range. From 102, in 103, a brake release counter is reset to zero. The brake release counter measures the amount of time the brake is in the release state after the first release. Subsequently, in 112, the reverse speed restriction is, if such restriction is currently being performed, no longer performed.

On the other hand, if it is determined in 101 that the current shift range is in the R-range (101:Yes), the process proceeds to 104. In 104, based on an output signal from the brake switch 15, the process determines whether the brake is ON (i.e., the brake operation is being performed). If the brake is not ON (i.e., the brake is released) (104:No) the process proceeds to 105 to set a brake release flag to an “ON”, which indicates that the brake operation is not being performed and the brake is in a released state, and the process proceeds to 106. If the brake is ON (104:Yes), the process directly proceeds to 106.

In 106, the process determines whether the brake release flag is “ON,” indicating that the brake is released. If the break release flag is “ON” (106: Yes), the process proceeds to 107, and increments the brake release counter. In such manner, the preset period of time from the first brake release after shifting to the R-range is measured.

Subsequently in 108, the process determines whether the value of the brake release counter is less than the preset period of time. The preset period of time may be set to, for example, 30 to represent 30 seconds, which may be considered as a normal time required for a driver to park a vehicle. The preset period of time may be set to a value other than 30.

When the value of the brake release counter is less than the restriction threshold (108:Yes), the process proceeds to 109, and the reverse speed restriction is performed for restricting the reverse speed of the vehicle to or below the restriction speed threshold, and then the process returns to start. The restriction placed on the reverse speed may limit the speed of the vehicle traveling in the reverse direction (i.e. the restriction speed threshold) to, for example, 10 km/h. Such restriction may be set in consideration of, for example, the safety the driver who may be an older driver or beginning driver. The restriction of the reverse speed or the restriction speed threshold, may be set to a speed other than 10 km/hr for the same or different reasons.

While the restriction is imposed on the reverse speed, the restriction on the reverse speed is effected by the repeated execution of the process at regular intervals. Accordingly, when the value of the brake release counter is not less than the restriction threshold (108:No), the process proceeds to step 110, and the restriction on the reverse speed is released. In other words, when 108 is No, the brake release counter has reached a value that exceeds the restriction threshold, and the restriction on the reverse speed is released. In addition, if the value of the brake release counter is equal to the restriction threshold, the control unit 13 may either continue the restriction of the reverse speed or may release the restriction of the reverse speed.

Subsequently, the process proceeds to 111, where the speed of the vehicle is gradually increased according to an operation of the accelerator pedal, and the vehicle is returned to a normal speed control with no restriction. The process then returns to the start of the process.

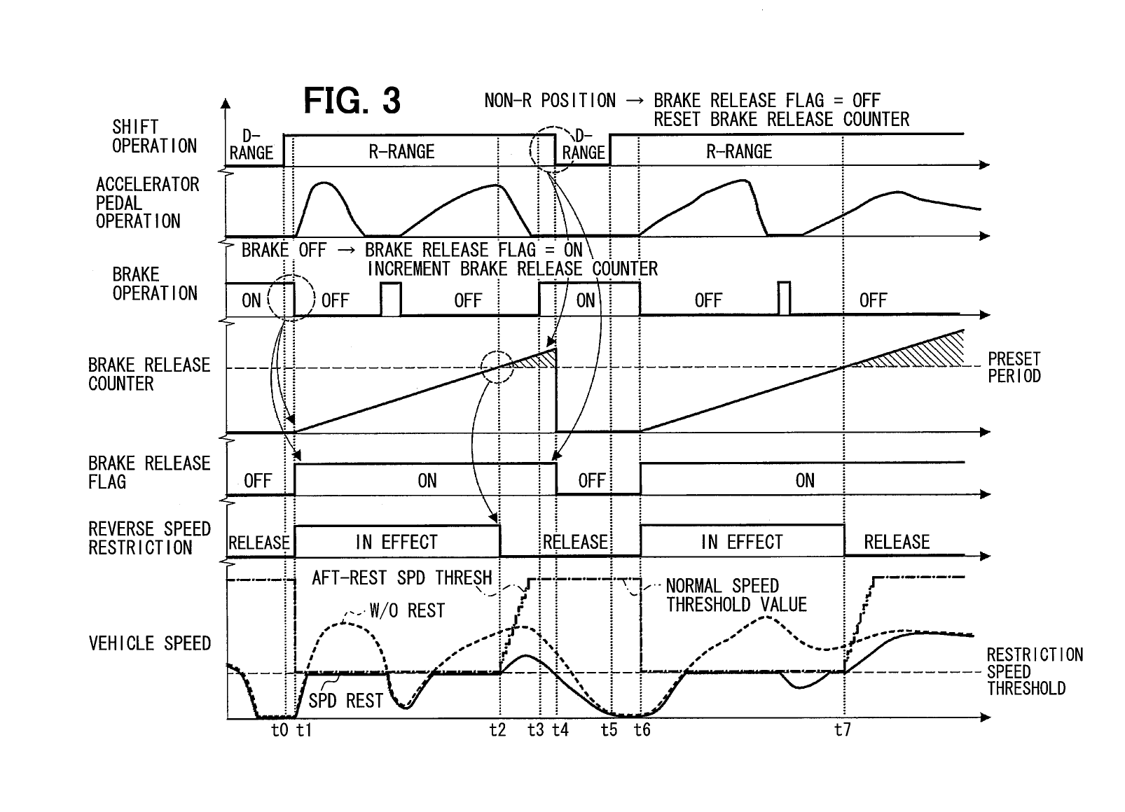

An example of an execution of the vehicle reverse speed control process of FIG. 2 is explained with reference to a time chart of FIG. 3.

In the example of FIG. 3, at time t0, the driver shifts the shift range from the drive range (D-range) to the R-range while operating the brake (i.e., brake ON). After changing to the R-range, at time t1, the brake is released (i.e., brake OFF) and the brake release flag is turned to the ON state for starting the restriction of the reverse speed, and the brake release counter is started to by incrementing the counter for counting the time after the first release of the brake (i.e., a reverse speed restriction execution time). In addition, the reverse speed restriction is performed.

During the restriction of the reverse speed, the reverse speed is maintained within the reserve speed threshold (e.g. less than or equal to 10 km/h). The reverse speed may change according to an operation of the brake pedal or the accelerator pedal. The reverse speed is restricted to the reserve speed threshold during the restriction, even if the vehicle may have a higher reverse speed during a normal speed control operation where the speed of the vehicle is primarily controlled by the operation of the accelerator pedal (i.e. there is no restriction). During the execution of the restriction on the reverse speed, the restriction of the reverse speed is continued (i.e., kept unchanged) regardless of ON and OFF of the brake.

At time t2, the brake release counter reaches the preset period of time, and the restriction on the reverse speed is released. The reverse speed of the vehicle gradually increases, as the speed threshold gradually increase.

Specifically, in order to prevent a sudden increase of the reverse speed, the maximum allowed speed (i.e. the speed threshold) gradually increase, such that the reverse speed is prevented from having a sudden speed threshold change from, for example, 10 km/h to 180 km/h.

At time t3, though the driver operates the brake (i.e., brake ON), the brake release counter continues to increment (i.e. count-up), because the brake release flag is kept unchanged from the ON state. In such manner, the restriction placed on the reverse speed is performed only after the first release of the brake after the shift range is changed to the R-range. Once the restriction on the reverse speed is released, the restriction will no longer be performed during the current reverse travel of the vehicle.

At time t4, the driver shifts the shift range from the R-range to the D-range (i.e., at a time when the reverse travel of the vehicle is finished), the brake release flag is changed to OFF and, substantially at the same time, the brake release counter is reset.

At time t5, as the driver shifts the shift range from the D-range to the R-range while operating the brake, and after such shift, when the brake is released (i.e., brake OFF) at time t6, the brake release flag is turned to the ON state for starting the restriction of the reverse speed, and the brake release counter is started to count the time after the first release of the brakes (i.e., reverse speed restriction execution time). At time t7, the value of the brake release counter reaches the preset period of time, and the restriction placed on the reverse speed is released.

In the above-described first embodiment, according to the configuration in which, subsequent to the shift to the R-range by the driver while operating the brake, the restriction on the reverse speed of the vehicle is performed after the first release of the brake, the vehicle control system prevents an unintentional increase of a reverse speed of the vehicle to an excessive degree due to a mis-operation of mistaking the accelerator pedal for the brake pedal during the backing of the vehicle. Further, because the vehicle driving torque is not restricted while the reverse speed of the vehicle is maintained at or below the restriction speed threshold, the driver can increase the vehicle driving torque by operating the accelerator pedal, when a torque increase is required for, for example, a backing of a substantially stopping vehicle right in front of a bump or the like.

Further, the reverse speed restriction is configured to be released after a preset period of time from the start of such restriction. Therefore, when the driver continues to operate the vehicle in a reverse direction (i.e. reverse gear), the driver can increase the reverse speed according to an operation of the accelerator pedal, after the preset period of time has been lapsed.

### Second Embodiment

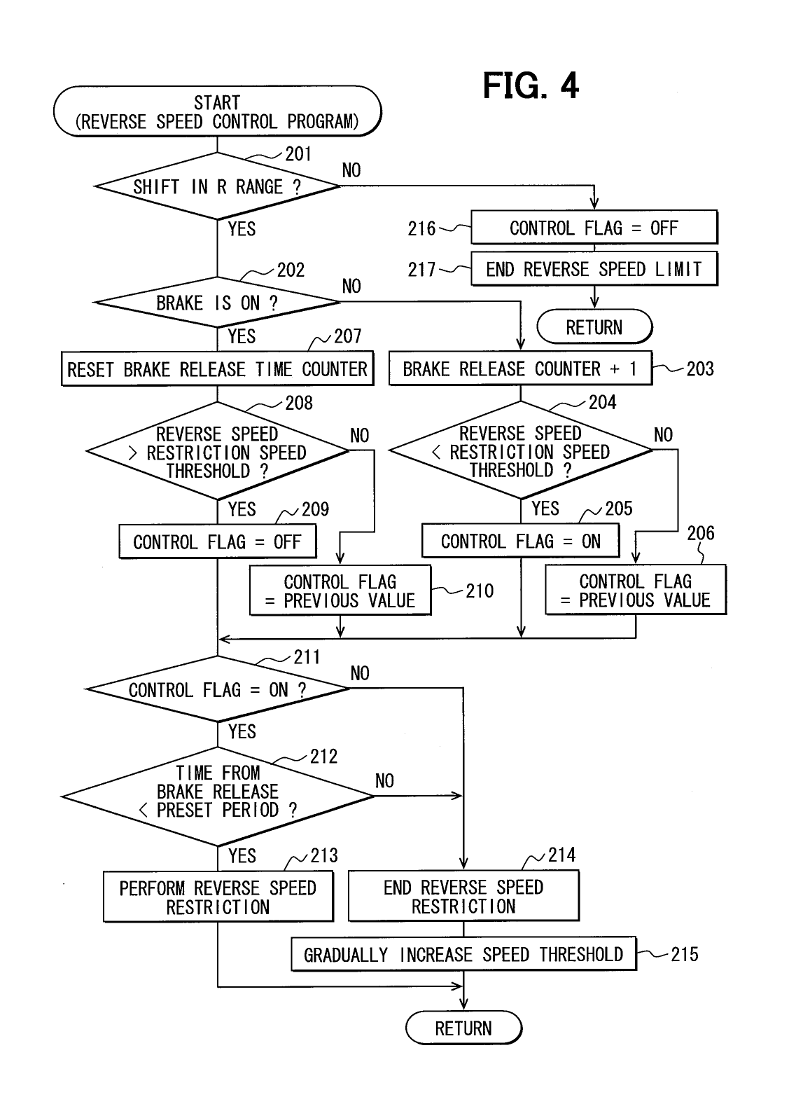

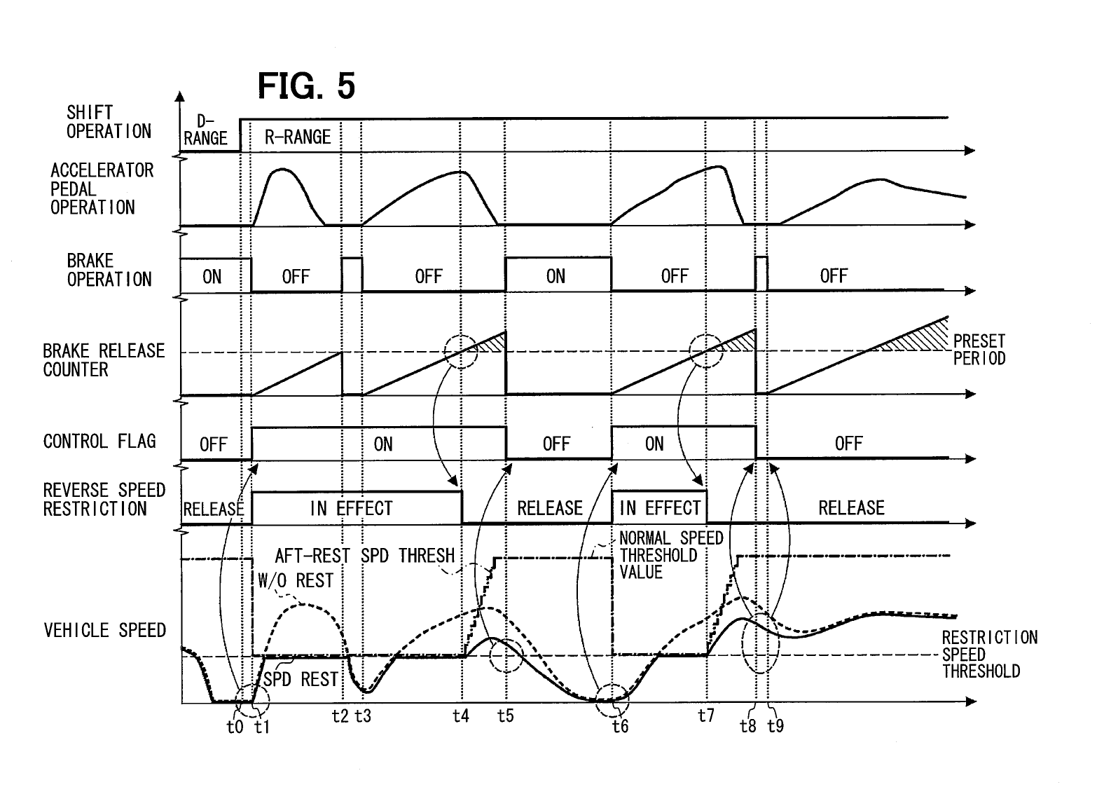

In the first embodiment, when the driver first releases the brake, after changing the shift range to the R-range while braking, a restriction on the reverse speed is performed for a preset period of time. In the second embodiment, as shown in FIG. 4 and FIG. 5, when the driver shifts the gear to the R-range while braking, the restriction on the reverse speed is performed for a preset period of time every time a release of the brake is detected. In this case, the preset period of time of the second embodiment may be set to a smaller value than the preset period of time of the first embodiment.

Further, in the second embodiment, after releasing the reverse speed restriction, if the vehicle is traveling in the reverse direction at a speed equal to or greater than the restriction speed threshold, a restriction on the reverse speed will not be performed even when a release of the brake is detected. The restriction may not be performed because it is likely that the driver is intentionally increasing the reverse speed. Therefore by not restricting the reverse speed, the driver is allowed to freely increase the reverse speed by operating the accelerator pedal. The other portion of the second embodiment is same as the first embodiment.

The restriction on the reverse speed is performed in the present embodiment by the control unit 13 in the following manner, according to the vehicle reverse speed control process of FIG. 4.

The vehicle reverse speed control process of FIG. 4 is performed repeatedly at regular intervals, while the control unit 13 is turned on. The process serves as a reverse speed restriction unit in claims.

The process, in 201, determines whether the current shift range is in the R-range. If the shift range is not in the R-range (201:No), the process proceeds to 216 to turn OFF a control flag, and then in 217 releases the restriction on the reverse speed if such restriction is currently being performed, and finishes the execution of the process.

If the process determines that the current shift range detected by the shift range detector 16 is in the R-range (201:Yes), the process proceeds to 202 to determine, based on the output signal from the brake switch 15, whether the brake is ON (i.e., the brake operation being performed). If the brake is not ON (i.e., the brake is released) (202:No), the process proceeds to 203 to increment a brake release counter. In such manner, if the shift range is switched to the R-range, every time the brake is released (i.e., the brake OFF), an elapsed time from the brake release is measured. The process proceeds to 204 to determine whether the reverse speed of the vehicle is smaller than a restriction speed threshold. The restriction speed threshold in this case is set to, for example, 10 km/h. The restriction speed threshold may be set to a value different from 10 km/hr. If the reverse speed is smaller than the restriction speed threshold (204:Yes), the control flag is turned to the ON state in 205, and if it is determined that the reverse speed is equal to or greater than the restriction speed threshold (204:No), the control flag is kept unchanged from the previous value in 206.

In 202, if the brake is ON (202:Yes), the process proceeds to 207 to reset the count value of the brake release counter for counting the brake release condition continuation time. The process proceeds to 208 to determine whether the reverse speed of the vehicle is greater than the restriction speed threshold. If the reverse speed is greater than the restriction speed threshold (208:Yes), the control flag is turned OFF in step 209. If the reverse speed is equal to or smaller than the restriction speed threshold (208:No), the control flag is kept unchanged from the previous value in 210.

As described above, in the process from 201 to 210, the control flag is set according to the comparison result between the reverse speed and the restriction speed threshold and the ON/OFF of the brake while the shift is in the R-range, and then, the process proceeds to 211. In 211, if the control flag is ON (211:Yes), the process proceeds to 212 to determine whether the value of the brake release counter exceeds the preset period of time. In the second embodiment, the preset period of time defines a time of performing the reverse speed restriction for every brake OFF (i.e. brake release), and the preset period of time has a smaller value than the preset period of time of the first embodiment, such as 10 seconds for the second embodiment and 30 seconds for the first embodiment.

If in 212 the time from the brake release has not exceeded the preset period of time (212:No), the process proceeds to step 213, thereby performing the reverse speed restriction for restricting the reverse speed of the vehicle to be equal to or smaller than the restriction speed threshold, and then the execution of the program is finished.

During the restriction of the reverse speed, the execution of the program is repeated at regular intervals, and, when it is determined that (a) the brake is ON and (b) the control flag is turned OFF due to the condition of the reverse speed>restriction speed threshold, it is determined as “No” in 212, and the process proceeds to 214, and the restriction on the reverse speed is released. Then, the process proceeds to 215, and the speed threshold of the vehicle is gradually increased, for returning the vehicle to a normal speed control and speed threshold, for example, 180 km/h, and the execution of the program is finished.

An example of execution of the above-described vehicle reverse speed control process of FIG. 4 is explained with reference to a time chart of FIG. 5.

In the example of FIG. 5, at time t0, the driver shifts the shift range from the D-range to the R-range while performing the brake operation (i.e., brake ON), and after such shift, at time t1, at which the brake is released, the control flag is turned to the ON state for starting the restriction on the reverse speed, and, at the same time, the brake release counter is started to count an elapsed time from the brake release (i.e. brake OFF) (i.e., the reverse speed restriction execution time).

While restricting the reverse speed, at time t2, at which the driver operates the brake (i.e., brake ON), the count value of the brake release counter is reset, and then, at time t3, the brake release counter is incremented to count the elapsed time from the brake OFF (i.e. the brake release). At time t4, at which the value of the brake release counter for counting the time from the brake OFF reaches the preset period of time, the restriction on the reverse speed is released, and the reverse speed gradually increases based on the driver's operation.

At time t5, a brake operation is performed (i.e., brake ON), the value of the brake release counter is reset, and, at the same time, the control flag is turned OFF. At time t6, at which the brake is released (i.e., brake OFF), the control flag is turned ON for starting the reverse speed restriction, and the brake release counter is incremented for counting the elapsed time from the brake OFF (i.e., the reverse speed restriction execution time). At time t7, at which the value of the brake release counter reaches the preset period of time, the reverse speed restriction is released, and the speed threshold and the reverse speed gradually increases.

At time t8, a brake operation is performed (i.e., brake ON), the value of the brake release counter is reset, and the control flag is turned OFF.

At time t9, even though the driver releases the brake (i.e., brake OFF), the reverse speed restriction will not be performed. This is because the control flag is kept unchanged from the OFF state due to, at time t9, the reverse speed exceeding the restriction speed threshold. In such manner, if the vehicle is traveling in the reverse direction at an over-the-threshold speed after the release of the reverse speed restriction, the reverse speed restriction will no longer be performed even when the brake is released, thereby allowing the driver to freely increase the reverse speed by operating the accelerator pedal according to his/her intention.

In the second embodiment according to the configuration in which, subsequent to the shift to the R-range by the driver while operating the brake, the restriction on the reverse speed of the vehicle is performed for a preset period of time every time the brake is released (i.e., brake OFF), a problematic situation due to a mis-operation of mistaking the accelerator pedal for the brake pedal during the reverse travel of the vehicle is more securely prevented.

For example, in the scheme of the first embodiment, once the driver releases the brake (i.e., the first brake release: t1 in FIG. 3) to drive the vehicle backward for, for example, parking, the reverse speed restriction will not be performed again after a subsequent brake release, that is, even when the driver operates the brake again to, for example, pick up a cellular phone call, and the brake is released again after such call, if such call is longer than the preset period of time from the first brake release. That is, in the first embodiment, when the reverse speed restriction is released, the restriction will not be performed for subsequent brake releases after expiration of the preset period of time. However, even in such situation of resuming reverse travel, the scheme in the second embodiment can appropriately perform the reverse speed restriction.

Based on the first embodiment of the present disclosure, the restriction on the reverse speed may be performed for a preset period of time from a first release of the brake operation after detecting the shift in the R-range. A mis-operation, such as mistaking the accelerator pedal for the brake pedal, is assumed at or after the first release of the brake, therefore, in order to prevent the mis-operation, a restriction on the reverse speed of the vehicle is provided only for a preset period of time after the first release of the brake. However, the restriction on the reverse speed may be performed immediately after shifting to the R-range for a preset period of time.

Alternatively, based on the second embodiment of the present disclosure, the restriction on the reverse speed may be performed for a preset period of time from a release of the brake operation whenever a release is detected after detecting the shift in the R-range. In such manner, a problematic situation due to a mis-operation is more securely prevented.

Additionally, when the reverse speed is greater than or equal to the restriction speed threshold after the restriction of the reverse speed is removed, no restriction is performed even when a release of a brake operation is detected. In such a case, the driver is most likely intentionally increasing the reverse speed over the restriction speed threshold, and by not restricting the reverse speed, the driver is allowed to freely increase the reverse speed by operating the accelerator pedal.

As a preventive measure, for both the first and second embodiment, when the reverse speed restriction is removed, a speed threshold of the vehicle may gradually be increased. In such manner, an unexpected sudden and steep increase of the reverse speed just after the release of the restriction is prevented, even when the driver of the vehicle is exerting a large depression force on to the accelerator pedal at the time the reverse speed restriction is released.

The power source 11 of the vehicle in the present disclosure may be one of the engine (i.e., an internal combustion engine) and the motor or may be both of them.

If the power source 11 for reversely driving the vehicle is the engine, the restriction on the reverse speed may be performed by at least one of an operation control of a brake actuator, a shift control of an automatic transmission, and a slip control of a clutch, without restricting an output of the engine. In such manner, the engine torque for driving the vehicle will not be restricted during a restriction time of the reverse speed, thus the driver can intentionally increase the vehicle driving torque.

On the other hand, if the power source for reversely driving the vehicle is the motor, the restriction on the reverse speed may be performed by a control of a motor rotation speed. Further, the restriction on the reverse speed may be performed by a feedback control of the brake actuator and the like even when the power source 11 is the motor, just like a case for the engine.

Although the present disclosure has been fully described in connection with preferred embodiment thereof with reference to the accompanying drawings, it is to be noted that various changes and modifications will become apparent to those skilled in the art.

For example, in each of the above embodiments, a selection function may be provided for allowing the driver to manually select from two modes, whether or not to perform the restriction on the reverse speed.

Further, the system may have a function that allows the driver to set a value of the restriction speed threshold of the reverse travel, and a time length for performing the reverse speed restriction (i.e. setting the preset period of time).

Further, the present disclosure may be applied to a vehicle that is not equipped with the brake actuator 18 that electronically control the braking force and the automatic transmission 12. Further, the processing method of the reverse speed control program in the present disclosure may be modified.

Such changes, modifications, and summarized schemes are to be understood as being within the scope of the present disclosure as defined by appended claims.

What is claimed is:

1. A reverse speed control apparatus disposed in a vehicle, the apparatus comprising:
a brake operation detection unit detecting a brake operation and a brake release of a brake disposed in the vehicle;
a shift range detection unit detecting a shift range of the vehicle; and
a reverse speed restriction unit performing a restriction on a reverse speed of the vehicle in accordance with a restriction speed threshold, wherein
when the brake operation detection unit detects a brake operation and the shift range detection unit detects shift range of the vehicle in a reverse range, the reverse speed restriction unit performs the restriction on the reverse speed of the vehicle after a brake release is detected by the brake operation detection unit.

2. The reverse speed control apparatus of claim 1, wherein the reverse speed restriction unit releases the restriction on the reverse speed after a preset period of time.

3. The reverse speed control apparatus of claim 2, wherein the reverse speed restriction unit performs the restriction on the reverse speed for the preset period of time from a first brake release detected by the brake operation detection unit after the detection of the shift operation to the reverse range by the shift range detection unit and the detection of a brake operation by the brake operation detection unit.

4. The reverse speed control apparatus of claim 2, wherein the reverse speed restriction unit performs the restriction on the reverse speed for the preset period of time from a brake release detected by the brake operation detection unit for each brake operation detected by the brake operation detection unit after the detection of the shift operation to the reverse range by the shift range detection unit.

5. The reverse speed control apparatus of claim 4, wherein, when the shift operation is in the reverse range and the reverse speed of the vehicle is greater than or equal to the restriction speed threshold after the restriction on the reverse speed is no longer performed, the reverse speed restriction unit does not perform a restriction on the reverse speed when a brake release is detected after a brake operation.

6. The reverse speed control apparatus of claim 1, wherein the reverse speed restriction unit gradually increases a speed threshold of the vehicle after the release of the restriction on the reverse speed.

7. The reverse speed control apparatus of claim 1, wherein when a power source of the vehicle is an engine, the reverse speed restriction unit performs the restriction on the reverse speed as at least one of an operation control of a brake actuator, a shift control of an automatic transmission, and a slip control of a clutch, without restricting an output of the engine.

8. The reverse speed control apparatus of claim 1, wherein when a power source of the vehicle is a motor, the reverse speed restriction unit performs the restriction on the reverse speed as a control of a motor rotation speed.
